(19) United States
(12) Patent Application Publication
(10) Pub. No.: US 2022/0092060 A1
(43) Pub. Date: Mar. 24, 2022

(54) SEMANTIC METADATA

(71) Applicant: Capricorn Holding Pte Ltd., Singapore (SG)

(72) Inventors: Sinuhé Arroyo, Singapore (SG); Carlos Ruiz Moreno, Madrid (ES); Guillermo Infante, Singapore (SG)

(21) Appl. No.: 17/025,827

(22) Filed: Sep. 18, 2020

(51) Int. Cl. G06F 16/245; G06F 16/23; G06F 16/22; G06F 16/25; G06F 40/30; G06F 40/169

(52) U.S. Cl. CPC G06F 16/245; G06F 16/2379; G06F 16/2228; G06F 3/04847; G06F 40/30; G06F 40/169; G06F 16/252

(57) ABSTRACT

A system and method for identifying a resource metadata, translating the metadata into a semantic representation of the metadata, including one or more concepts or instances and a relationship between the concepts or instances; generating an annotation, including the translated semantic metadata; receiving, from a client device, a semantic metadata search request including a first concept (or instance thereof), the relationship, and a second concept or instance thereof; selecting, from the database, the resource associated with the annotation matching the user input; and displaying, on the client device, a list including the resource.

### FIELD OF THE INVENTION

The disclosure relates in general to an electronic system for executing searches of resources such as electronic files and, more particularly, to a method and apparatus for storing one or more resources (possibly identified by resource type), extracting metadata from each of the resources, translating the metadata into semantic metadata according to a knowledge model/ontology, annotating the resources with semantic metadata, and returning search results annotated with semantic metadata matching associated search parameters.

### BRIEF SUMMARY

The disclosure relates in general to an electronic system executing multiple method steps for identifying a resource metadata, translating the metadata into a semantic representation of the metadata, including one or more concepts or instances and a relationship between the concepts or instances; generating an annotation, including the translated semantic metadata; receiving, from a client device, a semantic metadata search request including a first concept (or instance thereof), the relationship, and a second concept or instance thereof; selecting, from the database, the resource associated with the annotation matching the user input; and displaying, on the client device, a list including the resource.

### BRIEF DESCRIPTION OF THE DRAWINGS

FIG. 1 is a block diagram illustrating one example configuration of the functional components of the present semantic metadata system.

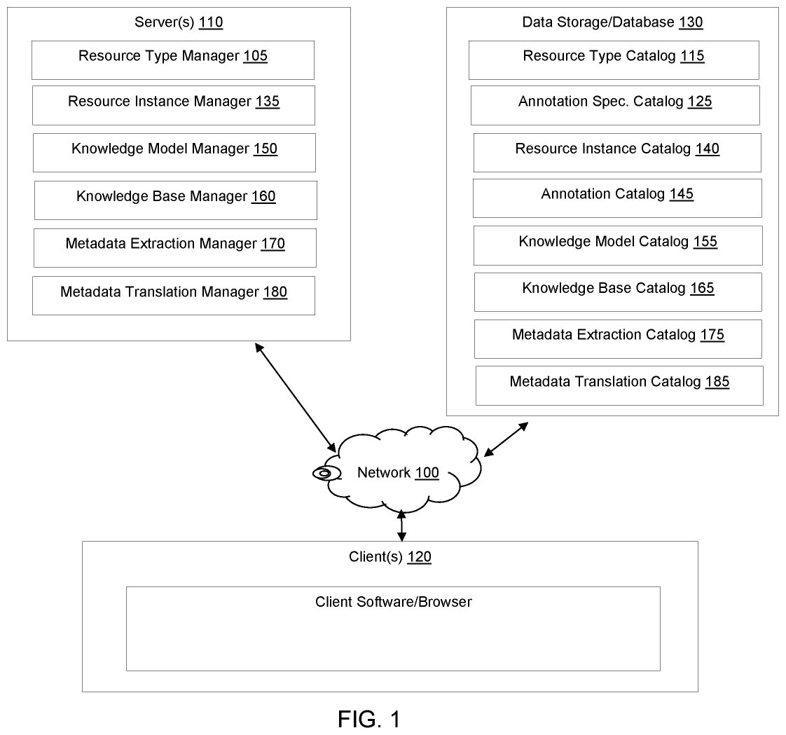

FIG. 2 is a screen shot illustrating one example configuration of the present system, allowing a user to create, read, update, and delete data relating to a resource type, an annotation specification, a resource instance, and/or an annotation associated with a resource instance.

FIG. 3 is a flowchart showing method steps for storing a resource in a resource repository, extracting metadata from the resource, translating the metadata into semantic metadata, and executing a semantic data search.

### DETAILED DESCRIPTION OF THE DRAWINGS

This invention is described in embodiments in the following description with reference to the Figures, in which like numbers represent the same or similar elements. Reference throughout this specification to “one embodiment,” “an embodiment,” “one implementation,” “an implementation,” or similar language means that a particular feature, structure, or characteristic described in connection with the embodiment is included in at least one embodiment of the present invention. Thus, appearances of the phrases “in one implementation,” “in an implementation,” and similar language throughout this specification may, but do not necessarily, all refer to the same embodiment.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Any schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

This disclosure addresses the process of accessing, translating and transforming metadata into semantic metadata. The disclosed embodiments describe a system for searching one or more resources (e.g., electronic files) within a resource repository, by identifying one or more search parameters within a search and matching these search parameters with one or more “annotations” (i.e., indexed data for finding the resource, such as metadata, tags, database records or fields, etc.) associated with each of the resources in the resource repository.

In some disclosed embodiments, the search parameters may include semantic search parameters within a semantic search, using parameters according to an ontology stored within a semantic model, also referred to herein as a knowledge model, which defines relationships between concepts, and stores instances of those concepts in an instance database, referred to herein as a knowledge base.

In some embodiments, the annotations and semantic search parameters relate to the content of each of the resources, and the search utilizes the annotations associated with each resource in the resource repository to identify matches with the semantic search parameters.

In some embodiments, the annotations and semantic search parameters relate to metadata derived from each of the resources, and the search utilizes the annotations associated with each resource in the resource repository to identify matches with the semantic search parameters, reflecting the metadata.

The disclosed systems and methods may therefore include one or more software modules configured to manage the creation, selection, updating, and deletion, as needed, for: one or more resource types categorizing one or more resources; one or more annotation specifications for defining the annotations associated with the resources; one or more resource instances; and one or more annotations associated with each of the one or more resource instances.

The disclosed systems and methods may further include one or more software modules configured to manage the creation, selection, updating, and deletion, as needed, for: one or more concepts to be stored in the model, ontology, and/or model database; one or more relationships to be stored in the model and/or model database; and one or more instances of the one or more concepts or relationships to be stored in an instance database;

Once the resource instances are created, annotated, and associated with a type, and once the concepts and/or relationships are established as an ontology within the model, and instances are stored within the instance database, the disclosed system may execute semantic searches, matching the search parameters based on the ontology with the instances of concepts and relationships within the annotations for the content of each of the resources.

In addition to semantic searches of the content of the resources, the disclosed embodiments may execute semantic searches of the metadata associated with each of the resources in the resource repository. The disclosed embodiments may include multiple types of metadata to be searched using the disclosed semantic metadata search. These types may include, as non-limiting examples: inherent metadata, located within the resource content or the resource itself; metadata included within a specialized file, possibly within specific tags (e.g., PDF metadata tags); derived metadata, derived by executing an algorithm such as a word count within a text file, for example; annotated metadata, created and managed separately from the resource itself, and so forth.

The disclosed systems and methods may further include one or more software modules configured to locate (within the “locations” above, based on metadata type) the metadata within, derived from, and/or related to, each of the resources in the resource repository, and extract it. The software modules may therefore include one or more “extractors,” so that as metadata or annotations are added or updated, extractors may also be added or updated (possibly dynamically) in order to be able to extract the new and/or changed metadata and/or annotations. The one or more extractors may have implementations corresponding to the locations above.(e.g., an extractor retrieves inherent metadata; implements the algorithm that calculates/derives metadata; and/or retrieves metadata from annotations).

Each metadata item that needs to have a semantic representation in a knowledge base, which stores instances of concepts, instances, and/or relationships from the knowledge model, must therefore have a corresponding extractor. However, extractors are not required to extract all metadata from any specific resource instance or resource type instance. One or more extractor software modules may therefore be configured to manage the creation, selection, updating, and deletion, as needed, for each extractor.

Once the extractors are configured, the extraction process may include receiving the resource identifier for a newly added resource, identifying one or more possible extractors associated with the resource, and invoking each of the extractors. The invocation of each of the extractors may include retrieving/extracting the metadata, and invoking one or more translator software modules, described below, to translate the extracted metadata into one or more instances to be stored in the instance database.

Once extracted (and because metadata may vary between individual specific resources and/or individual specific resource types, e.g., be formatted differently, reflect different metrics, etc.), the disclosed embodiments may translate the existing semantics and/or representations of metadata contained within, or associated with the resource, into concepts and relationships within the ontology/model, and/or instances of these concepts and relationships within the instance database, each of which may be associated with a corresponding extractor.

To accomplish this, the disclosed system may include one or more metadata translation rules used to translate the existing semantics and/or representations of the metadata into the concepts, relationships, and/or instances, according to the ontology/model, for storage in the instance database.

The disclosed systems and methods may therefore include one or more software modules configured to manage the creation, selection, updating, and deletion, as needed, for metadata translation rules, as well as one or more software modules configured to translate the metadata into the concepts, relationships, and/or instances according to the ontology/model and/or the instance database

A non-limiting example demonstrating the above steps may identify, within the system, a resource identifier representing an instance of the concept “ResourceIdentifier”. The instance of “ResourceIdentifier” and the instance of the extracted and translated metadata associated with the resource identifier may be stored in the instance database in association with the “HasMetaData” relationship (e.g., ResourceIdentifier HasMetadata [extracted and translated metadata]). If a resource identifier already exists within the instance database, the extracted and translated metadata may be added to it by means of the “HasMetaData” relationship.

In some embodiments, with each modification to the metadata, the metadata must again be extracted and translated for storage in the instance database. Alternatively, in some embodiments, the extraction and translation above may occur dynamically using late binding. The instance database may include a field indicating late binding so that when the instance database is accessed to retrieve the metadata, the metadata is extracted and translated. This may have its own latency problems, since it requires matching instances to the knowledge model.

Metadata items may be mandatory, but may be optional by default. The extractor may include a Boolean parameter indicating whether an associated metadata “isMandatory.” Some of the methods described above may therefore include an additional parameter indicating whether the metadata is mandatory, and if not found/extracted/translated, the method may fail.

All methods and steps described herein may be performed by any central processing unit (CPU) or other processor in a computer or computing system, such as a microprocessor running on a server computer 110, and executing instructions stored (perhaps as applications, scripts, apps, and/or other software) in computer-readable media accessible to the CPU or processor, such as a hard disk drive on a server computer 110, which may be communicatively coupled to a network 100 (including the Internet). Such software may include server-side software, client-side software, browser-implemented software (e.g., a browser plugin), and other software configurations.

In the interest of simplicity in describing the execution of method steps or other software instructions disclosed herein, the instant disclosure refers to a “server” 110. However, it should be understood that reference to a server 110 in this context is for simplicity only, and that the disclosed method steps may be accomplished by any components within the technological environment disclosed and described herein. As non-limiting examples, the method steps may be accomplished by any combination of a server 110, multiple servers 110, a client 120 or other user device, such as a desktop, laptop, mobile phone, tablet device, wearable media, etc., or by any other computer hardware or software described herein or known in the art.

This disclosure describes a system for semantic metadata management of resources within a knowledge store. The disclosed embodiments may include an aggregation of electronic data items, referred to herein as a knowledge store. The knowledge store may be comprised of one or more individual electronic data files or other electronic data items or elements, referred to herein as resources. The knowledge store contains the resources its users add over time and intend to keep. There is no limit to the variety of different types, quantity, or size of resources or other data files in the knowledge store. In the context of the disclosed embodiments, resources are managed objects.

Any object that has a representation and that can be stored in a computer system can be a resource. Resources may therefore exist in the main memory of a computer system, within persistent storage like the disks of a computer system, and/or may possibly reside in a file system that manages files on persistent disks. Each of these resources, as managed objects, may be individually identified within the system by a name and/or an identifier.

Each resource may include content, which a user may store and be able to retrieve at a later time. Each resource may therefore be represented as data on the system, such as a Word document or a PDF-formatted file. Therefore, the resources used in the semantic search targets, described below, include a variety of data within the resources. As non-limiting examples, resources may include documents, videos, audio files, or emails.

A resource is not limited to a single object, but may also be a collection of objects. The content within resources may be stored as multiple individual parts, and the sum of these individual parts may make up a collective data or content representation for the resource.

As a non-limiting example, a directory of files may be a single resource, or a group of documents, such as monthly industry reports. Similarly, a resource may be made up of a directory of emails, where the directory represents an email conversation made up of a discussion that may or may not have come to a conclusion, and each file is an individual email within that conversation or discussion. In some embodiments, the component parts of the resource may be hidden from users on a user interface.

A resource made up of a collection of objects may therefore be referred to in this disclosure as a composite resource, which is treated as a single resource type, described below. A composite resource may evolve over time by adding, updating, or removing the objects that make up the composite resource. Any data item that a user inserts into the knowledge store is a resource, irrespective of whether it is an individual video or an unfinished email conversation consisting of several emails, for example.

A distinction may be drawn between resource content (or information within the resource) and a representation for the resource. For example, an audio file and a file containing the text of a book may both be represented as binary data encoding. However, in some situations, the content in binary coding may not be capable of being derived. In order to reveal the content representation, the binary data encoding must be interpreted.

In order to accomplish this interpretation, the disclosed embodiments may run, and provide access to the user, via an interface, to a resource management software, which may include, as non-limiting examples, an editor or programming libraries configured and invoked to internally process and interpret the binary data encoding of a resource, thereby providing a user with a representation allowing them to access the content. Over time the representation of the binary data encoding of resources (e.g., Microsoft Word or Excel documents, as non-limiting examples), may change as the resource management software is updated with subsequent versions, etc., and the resource may be migrated from an older to a newer version accordingly.

Some resources may be of, or may be specific instances of a specific resource type. Resources in the disclosed embodiments may therefore be associated with resource types, and in some embodiments, each resource must be associated with at least one resource type within the disclosed system. However, multiple resource types may exist, and in some embodiments, each resource type may apply to one or more resource instances.

In some embodiments, the specific resource representation management software, described above, may be used to open resources of the same resource type. As non-limiting examples, a Word document (an instance of a resource) may be of type “WordDocument,” and all Word documents may be of the type “WordDocument.” Likewise, a PDF document may be of type “PDFDocument” and all PDF documents may be of the type “PDFDocument.” A resource representation management software, such as Word, may be used to open all representations for resources of resource type “WordDocument,” and a resource representation management software such as Adobe Acrobat, may be used to open all representations for resources of resource type “PDFDocument.”

A resource type may have a unique name and a unique identifier among all resource types. The unique identifier for the resource type is immutable once the resource type is created; however, the name of a resource type may change.

In some embodiments, a resource instance may not be associated with a resource type. In this case, the disclosed system may identify a generic, or default resource type (also referred to herein as a “TopResourceType”), and any resource instance that is not associated with a resource type may be implicitly or automatically associated with this generic or default resource type. This generic or default resource type may be used when the resource type of a resource instance cannot be determined or if a more appropriate or specific type is not available within the system.

As noted above, resource instances are in general accessed by a resource-type specific resource management software, and non-limiting examples include a word processor like Microsoft Word, a text editor, Adobe Framemaker, image processing software, video players, and so forth. In addition to accessing and interpreting the binary representations of a resource instance's content, a resource management software may further extract or update values from a resource, such as the metadata described below, as a non-limiting example. Using the examples above, resource type managers may be resource type specific, which may be distinguished from software, libraries, etc., used to parse text only files, which may or may not be resource type specific.

The disclosed embodiments may include a resource type manager 105, which includes one or more software modules configured to manage resource types. These software modules may further include instructions executed within memory by server 110. In some embodiments, these instructions may present an interface (e.g., a graphical user interface (GUI) or application programming interface (API)) configured to exchange data within the system and execute the software instructions.

In some embodiments, the interface of the resource type manager 105 is configured to list, create, read/get, update, and/or delete resource types, possibly using a Create, Read, Update, Delete (CRUD) functionality. In some embodiments, this functionality is accomplished according to one or more functions, methods, and/or operations, referred to herein as operations.

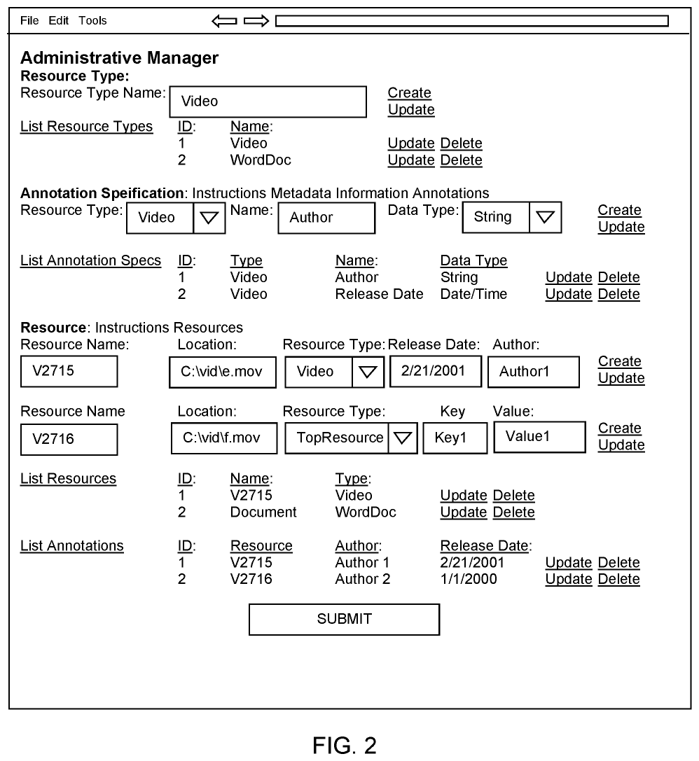

In embodiments that include a GUI, such as the non-limiting example GUI shown in FIG. 2, GUI elements may be provided to a user, allowing them to input the data, user inputs, requests, etc. needed for executing the CRUD and other functionality described herein.

As a non-limiting example, in FIG. 2, a user may input a resource type name and select a “Create” or “Update” link or button, thereby transmitting instructions to server 110 to execute the associated operations described below. Likewise, the user may select a “List Resource Types” link or button (and the associated “Edit” and “Delete” links or buttons for listed resource types) configured to transmit instructions to server 110 to execute the associated operations described below

The GUI may therefore implement resource type manager operations and provide feedback to the user regarding whether the operation was successful or not. For example, when a user tries to insert a resource type and refers to an already existing name, the user interface will not execute the operation and provide an error message to the user instead: it will state that the resource type already exists (and that a different name has to be chosen).

The resource type manager may include a listResourceTypes( ) operation, which takes no parameters in the operation, and lists all resource types that are in the system. This includes at least one resource type, the generic, default, or “TopResourceType.” The resource type manager may include a createResourceType(resource_type_name) operation, which takes, as a parameter, the resource type name, and adds a resource type with a specific type name to the system. This operation returns a unique type identifier, referenced above. If a type of the name exists, an error is returned. In case the resource type name already exists, an error message is displayed and no new resource type is added to the system. The resource type manager may include a getResourceType(resource_type_identifier) operation, which takes, as a parameter, the resource type identifier, and returns a resource type by name. The response type manager may include a getResourceType(resource_type_name) operation, which takes, as a parameter, the resource type name, and returns a resource type by identifier. The resource type manager may include an updateResourceType(resource_type_identifier, resource_type_name) operation, which takes, as parameters, the resource type identifier and resource type name, and changes the name of a resource type if the name is not yet used. The resource type manager may include a deleteResourceType(resource_type_identifier) operation, which takes, as a parameter, a resource type identifier, and removes a resource type from the system. This operation may impact the system by causing resources of this type to be updated to be associated with the generic, default, or “TopResourceType.” However, if the resource is associated with another resource type, no changes may be made.

The resource types and their associated data may then be stored in a resource type catalog 115, which may be contained within database 130.

The disclosed embodiments may include one or more annotations, which, in some embodiments, may be defined as data or other information that is not capable of being stored within a representation (or interpretation) of an instance of a resource or resource type. In the disclosed embodiments, a resource type may reference one or more annotation specifications, which define the details for an annotation associated with a resource instance, described in more detail below. In some embodiments, these annotation specifications may include a name and a data type.

In embodiments in which a resource type references one or more annotation specifications, instances of resources of this resource type may be required to be associated within the system with these annotations. By requiring the association of resource types and annotations, the disclosed system is able to support uniform annotations among resource instances of a specific resource type. For example, in some embodiments, a specific resource type may have an annotation specifying mandatory data defining a creator and/or owner of the resource instance.

The resource type manager 105 and/or an annotation specification manager may further include one or more software modules configured to manage annotation specifications. These software modules may further include instructions executed within memory by server 110. In some embodiments, these instructions may present an interface (e.g., a GUI or API) configured to exchange data within the system and execute the software instructions. In some embodiments, the interface of the resource type manager 105 may be configured to list, create, read/get, update, and/or delete annotation specifications, possibly using CRUD functionality. In some embodiments, this functionality is accomplished according to one or more operations, described below.

In embodiments that include a GUI, GUI elements may be provided to a user, allowing them to input the data, user inputs, requests, etc. needed for executing the CRUD and other functionality described herein.

As a non-limiting example, in FIG. 2, a user may input an annotation specification resource type, name, and data type, and select a “Create” or “Update” link or button, thereby transmitting instructions to server 110 to execute the associated operations described below. Likewise, the user may select a “List Annotation Specs” link or button (and the associated “Edit” and “Delete” links or buttons for listed annotation specifications) configured to transmit instructions to server 110 to execute the associated operations described below

The user interface implements the annotation specification manager operations and provides feedback to the user indicating whether the operation was successful or not.

The resource type manager may include an addAnnotationSpecification(resource_type_identifier) operation, which takes, as a parameter, a resource type identifier, and adds an annotation specification to a resource type and returns an annotation specification identifier. The resource type manager may include a getAnnotationSpecification(annotation_specification_identifier) operation, which takes, as a parameter, an annotation specification identifier, and retrieves the annotation specification identifier with the given identifier. The resource type manager may include an updateAnnotationSpecification(annotation_specification_identifier, annotation_specification) operation, which takes, as parameters, an annotation specification identifier and an annotation specification, and updates an annotation specification with the given identifier. The resource may include a deleteAnnotationSpecification(annotation_specification_identifier) operation, which takes, as a parameter, an annotation specification identifier, and removes an annotation specification with the given identifier.

The annotation specifications and their associated data may then be stored in an annotation specification catalog 125, which may be contained within database 130.

The disclosed embodiments deal with resources and resource instances, both of which may be used as synonyms in this disclosure. Each resource instance may be of a resource type, and may be associated with one or more resource types. In other words, a resource instance may be simultaneously associated with multiple resource types at the same time. As a non-limiting example, a resource instance may simultaneously be of type “PDF document,” “Financial Document,” and “Quarterly Report.” This becomes significant in cases where the metadata extraction, described below, is determined based on resource type.

If a resource instance is not associated with a resource type, the resource instance may be associated with a generic or default resource type, described above. Each resource instance may be associated with a unique identifier that is immutable, and which the system may use to refer to the resource instance.

In some embodiments, the disclosed system may determine a resource type for a resource instance based on the content within the resource instance. By contrast, in some cases, the disclosed system may not be able to determine the resource type from the resource content, and the resource type may not be explicitly defined. In cases where the resource type is impossible to determine, the disclosed system may associate the resource with a generic or default “catch-all” resource type, as described above.

The disclosed embodiments may include a resource instance manager 135, which includes one or more software modules configured to manage resource instances. These software modules may further include instructions executed within memory by server 110. In some embodiments, these instructions may present an interface (e.g., a GUI or API) configured to exchange data within the system and execute the software instructions. In some embodiments, the interface of the resource instance manager is configured to list, create, read/get, update, and/or delete resource instances, possibly using CRUD functionality. In some embodiments, this functionality is accomplished according to one or more functions, methods, and/or operations, referred to herein as operations.

In embodiments that include a GUI, GUI elements may be provided to a user, allowing them to input the data, user inputs, requests, etc. needed for executing the CRUD and other functionality described herein.

As a non-limiting example, in FIG. 2, a user may input a resource instance resource name, location, and resource type, along with additional data associated with the resource or resource type, such as release date and author, possibly associated with the selected Video data type in this example. The user may then select a “Create” or “Update” link or button, thereby transmitting instructions to server 110 to execute the associated operations described below. Likewise, the user may select a “List Resources” link or button (and the associated “Edit” and “Delete” links or buttons for listed resource instances) configured to transmit instructions to server 110 to execute the associated operations described below. In the non-limiting example in FIG. 2, a user may add a resource to the system by selecting a specified resource type (“Video”) as well as the location of the video in the file system.

The user interface implements the annotation specification manager operations and provides feedback to the user indicating whether the operation was successful or not. If the operation is successful, a resource identifier may be returned, and if not, an error message may be displayed.

The resource instance manager may include a listResources( ) operation, which takes no parameters in the operation, and lists all resource instances that are in the system. The resource instance manager may include an addResource(resource) operation, which takes, as a parameter, a resource instance, then adds a resource instance and returns a resource instance identifier. The type of the resource is automatically determined. If this is impossible, an error is returned. The resource instance manager may also include an addResource(resource, resource_type_identifier) operation, which takes, as parameters, a resource instance and a resource type identifier, adds a resource, and sets its resource type. The resource instance manager may include a getResource(resource_identifier) operation, which takes, as a parameter, a resource identifier, and retrieves a resource. The resource instance manager may include an updateResource(resource_identifier, resource) operation, which takes, as parameters, a resource identifier and a resource instance, and updates an existing resource. The resource instance manager may include a deleteResource(resource_identifier) operation, which takes, as a parameter, a resource identifier, and removes a resource.

In addition to creating resource instances, the disclosed embodiments, possibly a resource instance manager, may further create resource types associated with the resource instances. The resource instance manager may therefore include an addResourceType(resource_identifier, resource_type_identifier) operation, which takes, as parameters, a resource identifier and a resource type identifier, and adds an additional type to an existing resource. The resource instance manager may include a removeResourceType(resource_identifier, resource_type_identifier) operation, which takes, as parameters, a resource identifier and a resource type identifier, and removes a resource type. If this is the only resource type associated with the resource instance, an error may be returned. This operation may also remove metadata as a consequence of running the operation. As such, this operation may have a significant impact on the system.

The resource instances and their associated data may then be stored in a resource instance catalog 140, which may be contained within database 130.

A resource instance may have annotations that are not part of the resource representation itself. Because of this, annotations may be added to a resource instance. In some embodiments, such annotations may be required by the resource type, while in other embodiments, the associated annotation may be resource instance specific without being required by the resource type. The added annotations may be instances of the annotation specifications described above, and therefore may refer to a specific annotation specification, and may have a value of a data type specified within the annotation specification.

In some embodiments, annotations may be managed by the resource instance management software 135. For example, a file system may store and make additional information about a file accessible, which is not stored with the file itself. For example, annotations may store data about the owner of the resource, which may be separate from the creator of the resource, and which may be stored within the resource representation.

In embodiments of the resource instance management software 135 that include a GUI, GUI elements may be provided to a user, allowing them to input the data, user inputs, requests, etc. needed for executing the CRUD and other functionality described herein.

As a non-limiting example, in FIG. 2, a user may input an annotation instance (e.g., release date and author) along with any additional data associated with the annotation instance. The user may then select a “Create” or “Update” link or button, thereby transmitting instructions to server 110 to execute the associated operations described below. Likewise, the user may select a “List Annotations” link or button (and the associated “Edit” and “Delete” links or buttons for listed resource instances) configured to transmit instructions to server 110 to execute the associated operations described below

The resource instance manager may include a listResourceAnnotations(resource_identifier) operation, which takes, as a parameter, a resource identifier, and retrieves all annotations of a resource. The resource instance manager may include an addResourceAnnotations(resource_identifier, annotation_specification) operation, which takes, as parameters, a resource identifier and an annotation specification, and adds an annotation to a resource. The resource instance manager may include an updateResourceAnnotations(annotation_specification_identifier, annotation_specification) operation, which takes, as parameters, an annotation specification identifier and an annotation specification, and updates an annotation. The resource instance manager may include a deleteResourceAnnotations(annotation_specification_identifier) operation, which takes, as a parameter, an annotation specification identifier, and deletes an annotation from a resource.

The annotation instances and their associated data may then be stored in a resource instance annotation catalog 145, which may be contained within database 130.

Because resource instances are instances of resource types, it should be noted, regarding resource types and resource instances, that in some embodiments, resource types may be described in a knowledge model, and resource instances may be managed in a knowledge base. The resource type manager and resource instance manager may therefore be implemented by using the knowledge base and knowledge model, described below, as underlying components.

However, in the interest of clarity of description and explanation, the resource type manager and the resource instance manager, whose implementation is described above, are described separately from the knowledge model and knowledge base, described below, in this disclosure. However, this separation of descriptions does not add or remove system capabilities available through the combination of these concepts.

A knowledge model defines the concepts and their relationships that are available and can be used to describe data of resource instances. The definitions of the concepts, instances and relationships are therefore managed in a knowledge model (for example by means of one or more ontologies), and semantically annotated resources are stored in one or more knowledge bases. In some embodiments, each relationship refers to two concepts, so that the relationship and each of the concepts is considered a “triple” defining the relationship.

As a non-limiting example, described in more detail below, a metadata knowledge model defines the concepts and their relationships that are available and can be used to describe metadata associated with resource instances. For example, the concept “Length” and “Duration” with the relationship “isOfUnit” can be used to describe the length of a video recording measured in “Minutes”.

In some embodiments, the concept of a “ResourceIdentifier” must be present in the knowledge model, as instances of resource identifiers are used to relate metadata to resources. In order to relate resource identifiers to metadata, the relationship type “HasMetaData” must be present in the knowledge model since instances of this relationship relate metadata to resources.

The disclosed embodiments may include a knowledge model manager 150, which includes one or more software modules configured to manage the knowledge model in the disclosed embodiments. These software modules may further include instructions executed within memory by server 110. In some embodiments, these instructions may present an interface (e.g., a GUI or API) configured to exchange data within the system and execute the software instructions. In some embodiments, the interface of the knowledge model manager 150 is configured to list, create, read/get, update, and/or delete concepts and/or relationships in the knowledge model, possibly using CRUD functionality. In some embodiments, this functionality is accomplished according to one or more functions, methods, and/or operations, referred to herein as operations.

In embodiments that include a GUI, GUI elements may be provided to a user, allowing them to input the data, user inputs, requests, etc. needed for executing the CRUD and other functionality described herein. These user inputs may be analogous to the GUI seen in FIG. 2, possibly receiving user input from various design functionality, such as buttons, dropdown boxes, data entry fields, etc. However, the GUI associated with the knowledge model manager 150 may be configured to receive user input specifying the concepts and relationships described below.

The user interface may implement the knowledge model manager operations and provide feedback to the user indicating whether the operation was successful or not.

The knowledge model manager may include a listConcepts( ) operation, which takes no parameters, and lists all concepts in the knowledge model. The knowledge model manager may include a addConcept(concept_specification) operation, which takes, as a parameter, a concept specification, and adds a concept. This concept specification contains a concept name, as well as properties of the concept specification. The concept name is an identifier and must be unique. The knowledge model manager may include a getConcept(concept_name) operation, which takes, as a parameter, a concept name, and returns the concept specification for the given concept name. The knowledge model manager may include an updateConcept(concept_specification) operation, which takes, as a parameter, a concept specification, and updates a concept specification. The update must not change the name as it is a unique identifier for the concept. The knowledge model manager may include a deleteConcept(concept_name) operation, which takes, as a parameter, a concept name, and deletes a concept with the given name. Because it may change the metadata significantly, this operation may have a significant impact.

The knowledge model concepts and their associated data may then be stored in a knowledge model catalog 155, which may be contained within database 130.

The knowledge model manager may include a listRelationships( ) operation, which takes no parameters, and lists all relationships. The knowledge model manager may include a createRelationship(concept_name_a, concept_name_b, relationship_specification) operation, which takes, as parameter, a first concept name, a second concept name, and a relationship specification, and adds a directed relationship from concept A to concept B. Both concept A and concept B must exist. A relationship may have a unique name and further have properties. The knowledge model manager may include a getRelationship(relationship_name) operation, which takes, as parameter, a relationship name, and retrieves a relationship specification. The knowledge model manager may include an updateRelationship(relationship_specification) operation, which takes, as parameter, a relationship specification, and updates a relationship. However, the name must not be changed. The knowledge model manager may include a deleteRelationship(relationship_name) operation, which takes, as parameter, a relationship name, and removes a relationship. This deletion can have significant impact, as metadata might be removed as a side effect.

The knowledge model relationships and their associated data may then be stored in a knowledge model catalog 150, which may be contained within database 130.

Instances of the concepts and relationships in the knowledge model may be stored within a knowledge base. Thus, a knowledge base contains instances of concepts and relationships as defined by the knowledge model. As a non-limiting example, the knowledge base may contain a concept instance “5”, related to a relationship instance “isOfUnit” that in turn is related to a concept instance “Minutes.”

The disclosed embodiments may include a knowledge base manager 160, which includes one or more software modules configured to manage the knowledge base in the disclosed embodiments. These software modules may further include instructions executed within memory by server 110. In some embodiments, these instructions may present an interface (e.g., a GUI or API) configured to exchange data within the system and execute the software instructions. In some embodiments, the interface of the knowledge base manager 160 is configured to list, create, read/get, update, and/or delete instances of concepts and/or relationships in the knowledge base, possibly using CRUD functionality. In some embodiments, this functionality is accomplished according to one or more functions, methods, and/or operations, referred to herein as operations.

In addition, the knowledge base manager also ensures consistency, such as ensuring that a relationship instance connects two concept instances of the required concepts. Even though the knowledge base may include reference to a “ResourceIdentifier” it is not hard coded in the interface. By convention it is required when metadata about a resource instance, described herein, is added to the knowledge base and metadata for it is managed in the knowledge base.

In embodiments of the knowledge base manager 160 that include a GUI, GUI elements may be provided to a user, allowing them to input the data, user inputs, requests, etc. needed for executing the CRUD and other functionality described herein. These user inputs may be analogous to the GUI seen in FIG. 2, possibly receiving user input from various design functionality, such as buttons, dropdown boxes, data entry fields, etc. However, the GUI associated with the knowledge base manager 160 may be configured to receive user input specifying particular instances of the concepts and relationships described below.

The user interface may implement the knowledge base manager operations and provide feedback to the user indicating whether the operation was successful or not.

The knowledge base manager may include a listConceptInstances( ) operation, which takes no parameters, and retrieves all known concept instances. The knowledge base manager may include an addConceptInstance(concept_name, concept_instance_properties) operation, which takes, as parameters, a concept name and concept instance properties, and adds a concept instance for a given type. The property values may be supplied and the operation may return a concept instance identifier. The knowledge base manager may include a getConceptInstance(concept_instance_identifier) operation, which takes, as parameters, a concept instance identifier, and retrieves the properties of a concept instance. The knowledge base manager may include an updateConceptInstance(concept_instance_identifier, concept instance properties) operation, which takes, as parameters, a concept instance identifier and concept instance properties, and updates the existing properties with the new properties supplied. The knowledge base manager may include a deleteConceptInstance(concept_instance_identifier) operation, which takes, as parameters, a concept instance identifier, and removes a concept instance. This might have a significant impact on the metadata as relationships might be removed as well.

In addition to managing concept instances, the knowledge base manager 160 may further manage relationship instances, using the operations described below. The knowledge base manager may include a listRelationships( ) operation, which does not take any parameters, and lists all existing relationship instances. The knowledge base manager may include an addRelationships(relationship_name, relationship_instance_properties, concept_instance_identifier_a, concept_instance_identifier_b) operation, which takes, as parameters, a relationship name, relationship instance properties, a first concept instance identifier, and a second concept instance identifier, and adds a relationship instance between concept instances as defined by the relationship type. The properties of the relationship are supplied and a relationship instance identifier is returned. The knowledge base manager may include a getRelationship(relationship_instance_identifier) operation, which takes, as a parameter, a relationship instance identifier, and retrieves the properties of a relationship instance. The knowledge base manager may include an updateRelationship(relationship_instance_identifier, relationship_instance_properties) operation, which takes, as parameters, a relationship instance identifier and relationship instance properties, and updates a relationship instance with new property values. The knowledge base manager may include a deleteRelationship(relationship_instance_identifier) operation, which takes, as a parameter, a relationship instance identifier, and removes a relationship instance without removing the two corresponding concept instances.

The knowledge base concept and relationship instances, and their associated data, may then be stored in a knowledge base instance catalog 165, which may be contained within database 130.

The disclosed embodiments may further include annotations and/or annotation instances, which are described herein, and represent data that is available to semantic search. The semantic search, also referred to as semantic query processing, as described herein may be a search run by one or more semantic search software modules within the disclosed system, which are configured to formulate one or several semantic queries and access the knowledge store to examine or otherwise analyze the resources' contents, in order to determine if a given resource must be contained in a semantic query result. Secondary data structures like indexes might be used to speed up the semantic query processing.

Thus, in order to accomplish such a semantic search, the contents might be indexed or annotated with ontology concepts, instances, and/or relationships, as described above, for faster and more precise retrieval. Advanced semantic query processors, also referred to as semantic search engines may return not only semantic query results but also indicate a confidence indicator for each resource in the result set based on rules determining the level of confidence.

The description above may specifically refer to a semantic search to identify search results for resources based on content. In these embodiments, a semantic search focuses on the content of resources. In order to have a meaningful semantic search, resources may be annotated with semantic concepts, instances and relationships that express meaning about a resource's contents.

However, content is not the only important data associated with resources. Resources each have additional properties, such as their size, a date when they were last modified, their access history, etc., which describe these properties and other aspects of the resources, which are either independent of their content or related to their content but distinct from the content itself. These properties about a resource are referred to herein as the metadata of a resource.

As used in this disclosure, metadata may refer to data about data, and may be data within a resource's native representation. In some embodiments, the metadata available for a given resource may depend on the resource type or the resource itself. In embodiments where the metadata depends on the resource type, all instances of resources of that resource type may be required to have that metadata. In some embodiments, the required metadata may be defined within an annotation associated with the resource or resource type. As a non-limiting example, the email instance associated with an email type may be required to include a sender and a receiver, and thus, the required metadata (sender and receiver) is determined by the resource type associated with the resource instance. In some embodiments, additional metadata and/or annotations for a resource that are not prescribed by the corresponding resource type may be included, which are distinct from the metadata required for a resource instance of that resource type.

In some embodiments, the resources may not be associated with a specific resource type, as described above. In these instances, no metadata, or only metadata associated with the generic or default resource type may be associated with these resources. In this case the metadata is associated with the resource instance, as no specific resource type exists.

The annotations referred to above may include metadata made available to a semantic search. Thus, a semantic search, as described above, may be executed searching for more than the resource's content. In some embodiments, the metadata, or in other words, the resource's properties, which describe the resource independent of the actual semantic content, may be used in a semantic search.

As a non-limiting example, a user/system administrator may remember that a resource was large, according to the size of its content/data representation, but not remember other specific details about the resource. In this case, a search may be executed, searching for all resources that are larger than, for example, 10 GB, and may return, as search results, all large resources, which may include the resource the user was searching for. As another example, the user above might search for large and not recently accessed resources to see if they can be stored on offline long-term backup in order to save space in the online knowledge store.

The disclosed system may therefore be configured to access, extract, analyze, translate, insert, retrieve, update, delete, and/or otherwise manage the metadata associated with each resource in the knowledge store.

The disclosed system may include different components that may interact with each other to provide the desired metadata management functionality. In some embodiments, in addition to the interfaces above, the disclosed system may include explicit interfaces, such as application programming interfaces and user interfaces, which are configured to access resources within the knowledge store, and manipulate the stored information in order to extract it.

To configure the disclosed system to search the knowledge store in order to execute such a semantic metadata search, the disclosed system may access, retrieve, extract and/or otherwise manage metadata associated with each resource within the knowledge store.

However, the disclosed system does not require that all metadata be extracted from each resource, but only that metadata needed to create entries in the knowledge store, according to the knowledge model, in order to store annotations to be searched in response to a semantic metadata searches, described below in more detail.

The extraction of metadata is closely tied to multiple possible types of metadata, the location of this metadata, and a metadata extractor associated with a resource type. This metadata extractor for each resource or resource type, may be used to define the parameters used to extract the metadata, described below.

Specifically, the metadata may include: inherent metadata, which is semantic metadata that can be accessed or derived from the resource directly; any combination of inherent and non-inherent metadata, which may be derived from the resource directly or indirectly by examining the resource's contents; non-inherent metadata, which is completely independent of the resource, and so forth. The location of each of these types of metadata may act as a source for extraction in order to provide it as semantic metadata, described below.

Regarding inherent and non-inherent metadata, the disclosed resources may have certain inherent properties, such as their size (on disk or in memory), their storage location (or locations if there are several data representations in several places), the time and date when they were stored, their storage format, and so on. In some embodiments, the locations where the metadata is managed may be associated with the metadata types.

One non-limiting example of inherent metadata is metadata that is directly stored within the resource representation for each resource. For example, the title or name of the creator for a document is stored in the representation of the document, and may be inherent metadata, which is stored as part of the content of the document. Another example may include a word count that is stored within the resource's contents.

The location of the inherent metadata may be within, and/or may be part of, the resource representation itself. This inherent metadata may be accessible using a resource management software (e.g., an editor or programming libraries) that can be invoked and that internally processes the resource's representation, such as Microsoft Word or Microsoft Excel. In some embodiments, the metadata may be accessible and retrieved directly through the invocation of API libraries that manage the representation of, in this example, Word or Excel documents that are stored in files. The resource management software may further be configured to access the resource's content, then interpret, extract, and/or or update values from a resource.

For resources that do not have resource management software available, metadata may still be available, which may be stored within the resource's representation at a specific location, such as a specific absolute location in the representation, or based on embedded markup tags. The success of such an approach may rely of multiple variations of means to interpret the representation, depending on the representation itself. As a non-limiting example, a location in a PDF document may start with <x:xmpmeta xmlns:x=“adobe:ns:meta/.” In order to retrieve the metadata, this particular location would need to be found within the resource's representation in order to retrieve one or more values for the metadata.

In some embodiments, the metadata may be derived from the representation, without the metadata being stored as part of the representation itself. In other words, in this context, derived metadata may be metadata that can be derived from the resource representation, but it is not directly stored or available from the representation itself.

As a non-limiting example, in some embodiments, metadata associated with a word count and/or the number of characters in a document may be counted and derived by computing the word count or character count and interpreting the resource representation. An alternative example of this type of derived metadata may include determining a size of a resource as stored on a computer disk by inquiring the storage manager for the size of the occupied storage space.

There are resources for which no specific or dedicated resource management software exists and metadata is not stored as part of their content. Thus, in some embodiments, the metadata may exist, despite not having a resource management software or an interpretable representation, but may be accessible without the use of a resource management software, and instead may be derived via interpretable content. In these embodiments, the disclosed system may manage metadata for these types of resources outside the resource representation, where the location of the metadata is stored in a separate storage location (different from the resource's representation itself), possibly analogous to annotations, described in more detail below.

For example, a text file (e.g., a non-self-describing format, such as ASCII) can be processed by various text processors, which store only the text itself. Similarly, the resource may be represented in a self-describing formal language like XML or JSON. In this example, a resource management software is not necessarily needed since the representation itself can be interpreted directly by means of parsers, text processing programming libraries, etc. Unlike type management software (e.g., Word, Adobe, etc.), parsers and libraries are not resource type specific, and therefore support any resource type as long as the representation is in a formal supported language.

As another example, the metadata may reflect the storage space that a resource occupies, or the time/date stamp reflecting when the resource was first stored. In this example, only circumstantial metadata would be obtainable.

Resources may also have metadata that is not part of the resource's inherent properties, known as non-inherent metadata. In these types of resources, the resource does not directly contain the metadata in its content and therefore is not stored or accessible directly as metadata.

In some embodiments that include this non-inherent metadata, in order to access the metadata, the metadata needs to be derived from the resource's content. This content is not part of the inherent properties representing the metadata. As a non-limiting example, such metadata may include specific people that are mentioned in the resource.

In an example similar to that above, non-inherent metadata may also be identified and accessed by executing an algorithm, such as computing the number of characters in a resource.

In some embodiments that include non-inherent metadata, the metadata may be annotated metadata, which is not part of the resource representation at all, but may be added as a separately managed data structure (e.g., an annotation data structure), and managed separately from the resource representation. Such annotated metadata may be derived from the resource representation, but does not have to be. The annotated metadata and its management may be independent of the resource representation. For example, while a document might store its creator, it might not have the facility to store its owner. In that case the owner's name would be added as an annotation.

The example metadata types described above are for example purposes only, and are non-limiting. Any type of metadata may be applied to the metadata extraction and translation techniques described herein. Furthermore, resource instances, as disclosed herein, may be associated with one or more of the different types of metadata at the same time.

In some embodiments, each metadata item that needs to have a semantic representation in the knowledge base must have a corresponding extractor. A metadata extractor may comprise a component that retrieves and extracts metadata from a resource. Thus, each of these metadata extractors in the disclosed embodiments may be configured to locate metadata within (or associated with) a resource and extract it. Each resource or resource type may have any number of extractors related to it.

In some embodiments, unless an extractor is defined for a particular metadata, the metadata will not be added as semantic metadata to the knowledge base. It is therefore necessary to be able to add extractors dynamically as metadata is added to resources.

Because resources may have additional metadata added to them at any time as metadata or annotations associated with resources are added or change, extractors associated with the resources may be added or updated to reflect the new metadata or annotations. Furthermore, it is possible that a metadata extractor exists, but is not related to a resource type or a resource.

In some embodiments, an extractor may be a software function or process that is specifically implemented for a resource instance or resource type. Thus, in light of the various metadata types and locations described above, an extractor may have different implementations in various embodiments.

As non-limiting examples, one implementation may include extractors associated with metadata extracted using resource management software. Another implementation may include extractors associated with metadata extracted using generic format interpreters like for JSON, ASCII or XML. Another implementation may exist for metadata that is inherent metadata, in which the extractor is used to retrieve the metadata. In embodiments where the metadata is derived, the extractor may be configured to implement the algorithm that computes the derived value. In embodiments where the metadata is stored as annotated metadata, the extractor may be configured to retrieve the annotation associated with the metadata.

The disclosed system may include a metadata extraction manager 170, which includes one or more software modules configured to manage the metadata extractors described above, and manage the extraction of the metadata associated with the resources as described herein. The operations executed by the metadata extraction manager 170 are described below. The software modules may further include instructions executed within memory by server 110. In some embodiments, these instructions may present an interface (e.g., a GUI or API) configured to exchange data within the system and execute the software instructions. In some embodiments, the interface of the metadata extraction manager 170 is configured to list, create, read/get, update, and/or delete metadata extractors, possibly using CRUD functionality. In some embodiments, the metadata extraction manager 170 is configured to execute the metadata extraction described herein. In some embodiments, this functionality is accomplished according to one or more functions, methods, and/or operations, referred to herein as operations.

In embodiments of the metadata extraction manager 170 that include a GUI, GUI elements may be provided to a user, allowing them to input the data, user inputs, requests, etc. needed for executing the CRUD and other functionality described herein. These user inputs may be analogous to the GUI seen in FIG. 2, possibly receiving user input from various design functionality, such as buttons, dropdown boxes, data entry fields, etc. However, the GUI associated with the metadata extraction manager 170 may be configured to receive user input specifying details required by the metadata extraction operations described below.

The user interface may implement the metadata extraction manager operations and provide feedback to the user indicating whether the operation was successful or not.

The metadata extractor manager may include a listExtractors(resource_instance) operation, which takes, as a parameter, a resource instance, and retrieves all known extractors. The metadata extractor manager may include a listExtractors(resource_type) operation, which takes, as a parameter, a resource type, and retrieves all known extractors. The metadata extractor manager may include an addExtractor(resource_identifier, extractor) operation, which takes as parameters, a resource identifier and an extractor, and associates an extractor to a resource. The metadata extractor manager may include an addExtractor(resource_type_identifier, extractor) operation, which takes as parameters, a resource type identifier and an extractor, and associates an extractor to a resource type. The knowledge metadata extractor manager may include an updateExtractor(resource_identifier, extractor) operation, which takes as parameters, a resource identifier and an extractor, and updates an extractor associated with a resource. The metadata extractor manager may include an updateExtractor(resource_type_identifier, extractor) operation, which takes as parameters, a resource type identifier and an extractor, and updates an extractor associated to a resource type. The metadata extractor manager may include an deleteExtractor(resource_identifier, extractor) operation, which takes as parameters, a resource identifier and an extractor, and removes the association of an extractor with a resource. The metadata extractor manager may include an deleteExtractor(resource_type_identifier, extractor) operation, which takes as parameters, a resource type identifier and an extractor, and removes the association of an extractor with a resource type.

Since a resource may be of several resource types at the same time, different extractors may be associated with a resource because it is of several types. For example, if a resource is a “Financial Document” and a “Quarterly Report” at the same time, all extractors related to “Financial Document” and “Quarterly Report” may apply.

The metadata extractors, and their associated data, may then be stored in a metadata extraction catalog 175, which may be contained within database 130.

In addition to the metadata extractor manager, the disclosed system may further include a metadata extraction manager 170 configured to execute the extraction of the metadata from the resources, using the metadata extractors described above. Thus, in some embodiments, the metadata extraction manager 170 and the metadata extractor manager may work in tandem to extract the metadata from the resources. The metadata extraction manager may therefore include an extractMetadata(resource) operation, which takes as a parameter, a resource, and extracts the metadata of a resource with help of the associated extractors.

It should be noted that for composite resources, the extraction process must operate according to the multiple resources that are part of the composition. In addition, extractors associated with a composite resource type or resource instance may internally iterate through the composed resources in order to extract metadata from the composite resource. As a non-limiting example, an email conversation may consist of a number of individual emails. An extractor may count the number of emails, and utilize this number in the process of extracting metadata from the composite resource.

It should further be noted that when a resource instance is deleted, its associated metadata is removed. Such removal of metadata does not require the execution of extractors. By contrast, when a resource is updated, all extractors are executed again, and the metadata is updated so that the metadata corresponds to the updated resource.

The following may summarize the process for metadata extraction, and further outline the process for metadata translation, and storage of the metadata translation within the knowledge base, in association with the knowledge model: first, the disclosed system may receive the resource identifier of the newly added resource, as described above. For the given resource, the disclosed system may determine all associated extractors. It should be further noted that a resource may have different types of metadata at the same time, so more than one extractor may be associated with a resource. Next, the disclosed system may invoke each of the extractors to first, retrieve the metadata (as described above), and second, invoke a translator for each metadata to translate into the corresponding instances of the knowledge model since, generally speaking, resources store metadata in different ways, requiring a translation to a uniform structure. Finally, the disclosed system may store the instances representing the metadata into the knowledge base, as directed by the knowledge model. Thus, once the metadata is extracted, the metadata extractor may use the metadata translator to convert the metadata specific to the resource into its knowledge model representation.

The disclosed system may include a metadata translation manager 180, which includes one or more software modules configured to manage the metadata extractors described above, and manage the extraction of the metadata associated with the resources as described herein. The operations executed by the metadata translation manager 180 are described below. The software modules may further include instructions executed within memory by server 110.

One of the software modules described above may include one or more metadata translator software modules, including a metadata translator. A metadata translator may be a component that extracts metadata of a resource and returns a translation of the metadata into an equivalent relationship between concepts and/or instances, and is stored within the knowledge base.

To accomplish the metadata translation described above, the disclosed system may access one or more translation rules. In other words, the metadata translator may include a corresponding rule database, accessible to the metadata translator software, which manages all rules that need to be executed for metadata translation. The translation rules within this rule base may control the translation process by receiving the resource metadata as input (after extraction), and producing concept and relationship instances as output.

In order to apply the proper translation rules, the metadata translator software may be configured to identify both the resource (identified by a ResourceIdentifier or a resource type) and the metadata being translated. In other words, each of the translation rules may be related to a resource and its associated metadata.

In some embodiments, the instructions within the metadata translator software modules may present an interface (e.g., a GUI or API) configured to exchange data within the system and execute the software instructions. In some embodiments, the interface of the metadata translation manager is configured to list, create, read/get, update, and/or delete metadata translation rules, possibly using CRUD functionality. In some embodiments, the metadata translation manager 180 is configured to execute the metadata translation described herein. In some embodiments, this functionality is accomplished according to one or more functions, methods, and/or operations, referred to herein as operations.

In embodiments of the metadata translation manager 180 that include a GUI, GUI elements may be provided to a user, allowing them to input the data, user inputs, requests, etc. needed for executing the CRUD and other functionality described herein. These user inputs may be analogous to the GUI seen in FIG. 2, possibly receiving user input from various design functionality, such as buttons, dropdown boxes, data entry fields, etc. However, the GUI associated with the metadata translation manager 170 may be configured to receive user input specifying details required by the metadata translation operations described below.

The user interface may implement the metadata translation manager operations and provide feedback to the user indicating whether the operation was successful or not.

The metadata translation manager may include a listTranslationRules(resource_type_identifier) operation, which takes, as a parameter, a resource type identifier, and lists all rules associated with a resource type. The metadata translation manager may include a listTranslationRules(resource_instance) operation, which takes, as a parameter, a resource instance, and lists all rules associated with a resource instance. The metadata translation manager may include an addTranslationRule(resource_type_identifier, translation_rule) operation, which takes, as parameters, a resource identifier and a translation rule, and associates a translation rule to a resource type. The metadata translation manager may include an addTranslationRule(resource_identifier, translation_rule) operation, which takes, as parameters, a resource identifier and a translation rule, and, associates a translation rule to a specific resource. The metadata translation manager may include an updateTranslationRule(resource_type_identifier, translation_rule) operation, which takes, as parameters, a resource type identifier and a translation rule, and updates the associated translation rule. The metadata translation manager may include an updateTranslationRule(resource_identifier, translation_rule) operation, which takes, as parameters, a resource identifier and a translation rule, and updates the translation rule associated with a specific resource. The metadata translation manager may include a deleteTranslationRule(resource_type_identifier, translation_rule) operation, which takes, as parameters, a resource type identifier and a translation rule, and removes the association with the resource type. The metadata translation manager may include a deleteTranslationRule(resource_identifier, translation_rule) operation, which takes, as parameters, a resource identifier and a translation rule, and removes the association with the resource instance.

In addition to the metadata translation rule manager, the disclosed system may further include a metadata translation manager 180 configured to execute the translation of the metadata from the native representations of metadata to semantic metadata resources, using the translation rules described above. Thus, in some embodiments, the metadata translation manager 180 and the metadata translation rules manager may work in tandem to translate the metadata from native representations of metadata to semantic metadata. The metadata translation manager 180 may therefore include a translateMetadata(resource, metadata) operation, which takes as parameters, a resource and a metadata, and translates the metadata for the given resource based on the associated translation rules.

After the translation takes place, the translated metadata (aka, instances of concepts and relationships) is inserted into the knowledge base by relating it to the resource and/or resource type identifier.

Given the resource and the extracted metadata, the metadata is therefore translated according to the knowledge model concepts and relationships (creating a relationship independent from the native representation), and the knowledge base is populated after the translation from the native representation of the metadata into instances of concept and relationships as defined by the knowledge base.

The instance of the metadata created in the knowledge base is associated with a resource identifier, which an instance of the concept “ResourceIdentifier.”. If the resource identifier is already part of the knowledge base, the metadata is added to it by means of the “HasMetaData” relationship. Otherwise the resource identifier may be created and the relationship may then be established.

In some embodiments, the metadata extraction described above explicitly binds the metadata to its knowledge model representation and stores the instances into the knowledge base. These embodiments require that every time the resource is modified (or deleted), the metadata has to be extracted, translated and stored again.

Alternative embodiments may involve late binding of extraction and translation. In these embodiments, the extraction and translation of the metadata is dynamic, so that instead of adding the metadata instances into the knowledge base, it is noted in the knowledge base that a resource has late binding metadata extraction and translation. Upon access of the knowledge base to retrieve the metadata for a resource, the metadata is dynamically extracted and translated, ensuring that the metadata in the knowledge base is always up-to-date as it is dynamically computed when needed. However, this approach also means that any access incurs increased access latency as the extraction and translation algorithm has to run first before the instances matching the knowledge model are known.

The extracted and translated metadata may be used by a semantic search, analogous to the content searches described above, in order to search for resources according to their associated metadata. The resources accessible to such a dynamic search may include data such as documents, videos, pictures, emails, audio recordings, etc.

Thus, in the context of this disclosure, semantic metadata is knowledge about resources in the form of instances of concepts and relationships, which are defined within the knowledge model and its semantic metadata ontology. Instances of these concepts and relationships may be stored within the knowledge base.

The semantic metadata described herein may include many features and method steps, as outlined below. Semantic metadata is data about data, meaning data that describes data itself, which may be useful to users or administrators of the knowledge store. Semantic metadata may define very different aspects of a resource or data in the knowledge store, including aspects defining the resource or data itself, or aspects that are context-independent such as the resource's size and the language in which it is written. Semantic metadata may also address the resource's life cycle, the time and date when data was stored or created first in the knowledge store, when it was last modified or deleted, whether it was modified or accessed over time, a history of this access behavior, and the like. Semantic metadata may include a resource's type of content, such as a legal document, a memorandum, or an email, or may be a single property of the resource, such as a video encoding or duration of a video. Semantic metadata may also include a set or a group of resources, such as a total page count of all monthly reports of a fiscal year.

Semantic metadata may reflect the status of resources. For example, a resource (e.g., a photo) may be finalized, or it may be in progress, such as an ongoing video stream, where, if the video stream is too large, it is closed and a second stream is opened that contains the continuation of the first stream. In such a case, the resource's content representation may connect or group the multiple streams into an ordered set, so that it is possible to recreate the correct and complete order.

Semantic metadata itself may be found in several locations relative to the resource. Some resources in the knowledge base have semantic metadata contained inside their data representation, whereas other metadata might not be part of the resource representation, but stored separately in the knowledge store itself and related to the resource. As a non-limiting example, a document might contain information regarding when it was created, but not when it was added to the knowledge store.

Semantic metadata can be explicit or implicit. For example, the word count might be stored inside the resource's representation as a number or the resource may have a function that can compute the word count on demand every time it is queried. Semantic metadata may be independent of a measure or context, like a word count. Semantic metadata may also be dependent on the context. For example, the timestamp indicating when a resource was stored is not meaningful without knowing the time zone. In this case, the context (e.g., the time zone identified by a software component that wrote the time, or the time zone of the knowledge store) must be available to interpret the semantic metadata or storage time correctly.

Semantic metadata contained in a resource's representation can only be used by a semantic search component if it is accessible by the knowledge store. If the knowledge store is not able to access semantic metadata stored as part of the resource (i.e. the semantic metadata is inaccessible), the semantic metadata may be replicated inside the knowledge store so that it is accessible by a semantic query component (e.g., as an annotation).

Semantic metadata may be extended or expanded over time. For example, initially semantic metadata may not be required to identify the author of resources, but at some point it might become required. In this situation, the concept ‘author’ may be added as possible semantic metadata, making it possible from that point forward to add this semantic metadata to existing as well as new resources in the knowledge store.

Semantic metadata may be system-defined or user-defined. In the context of this disclosure, system-defined may indicate that the semantic metadata is already configured in the knowledge store as a default set of semantic metadata (e.g., by an administrator) and available for use. In some embodiments, it is possible that system-defined semantic metadata cannot be specified by users directly, or may only be specified after an approval process so that the semantic metadata consistency is guaranteed. In the context of this disclosure, user-defined semantic metadata may be semantic metadata that users define and specify as they see fit or require. This allows end users to add additional semantic metadata to the system-defined semantic metadata. This distinction between system and user semantic metadata should not in any way limit the disclosed embodiments - other distinctions may be important in the context of a knowledge base, and other categorizations may also exist. System or user-defined metadata does not necessarily have to be defined for all resources in the knowledge store. Such metadata may be defined for specific resource types or for specific resources.

Semantic metadata may be defined for resource types and/or for individual resource instances. If semantic metadata is defined for a resource type, all resources of this type may be associated within the disclosed system with the semantic metadata. For example, all Word documents may be associated with a word count.

Regarding the ontology described above, semantic metadata may carry meaning, and the best way to reflect that meaning is a knowledge representation like an ontology based on semantic web technology. In order to capture the available system-defined and user-defined semantic metadata described above, a semantic metadata ontology may therefore be added to the knowledge model. Because a semantic metadata ontology is like any other ontology in principle and structure, it may be managed as such, and modified over time as needed.

System-defined semantic metadata applies to all resources within the knowledge store, and may therefore be a common denominator across all resources; ideally all resources have these semantic metadata items populated with the correct values. Additional semantic metadata may only apply to certain resource types or resources with specific content. A semantic metadata ontology, therefore, may be structured in such a way that semantic metadata may be categorized as needed in the knowledge store and related to resources as needed.

As a non-limiting example of application of a derived metadata as applied to a semantic metadata ontology described above, the semantic metadata ontology may contain the concept of “Person” and a relationship “mentions” between a resource and a person. Because “mentions” is a relationship between a resource and a person, it is therefore part of the metadata ontology, which makes it metadata. As another example, a document may mention a person called Cristiano Ronaldo. It is possible to annotate the document (resource) with “mentions Cristiano_Ronaldo”. This annotation may therefore constitute metadata about the document. In this example, an annotation is used to add semantic metadata to the document that is not inherently present in the (inherent) metadata the document contains by default.

Thus, as outlined earlier, semantic metadata may be added to a resource by means of annotations with concepts, instances or relationships of the semantic metadata ontology. This scenario covers non-inherent resource metadata. In this case the metadata is represented as an association and stored as such (e.g. in the storage manager storing the resource); it is not located in the resource or outside the resource.

Semantic metadata may be added referring to inherent metadata also. For example, a document may contain its title as inherent metadata. The semantic metadata ontology may contain the concept of a “Document Title” and a relationship that a resource “has_title”. It is therefore possible to annotate the resource with the relationship and concept from the semantic metadata ontology, for example, resource “has_title” “The Roads to Madrid”.

By default metadata is optional. However, in some embodiments, metadata may be optional or mandatory, or in other words may be required and immutable Metadata. Such mandatory metadata may need to be present when the metadata of the resource is extracted. In these embodiments, it may be possible that several metadata items are mandatory, in which case, all metadata items need to be present at extraction time. If one of the extractions fails because the mandatory metadata is absent, then the whole extraction fails, in these embodiments.

In order to indicate that metadata is mandatory, an additional Boolean parameter “isMandatory” may be used in the disclosed system when adding or updating extractors. Thus, the following operations are the same as those above, but may include an added input parameter that specifies if the extractor extracts mandatory metadata. In some embodiments, if an extractor does not find the metadata, it fails.

The metadata extractor manager (or other software module) may therefore include an addExtractor(resource_identifier, extractor, is_mandatory) operation, which takes as parameters, a resource identifier, an extractor and a Boolean is_mandatory, specifying whether the extractor extracts mandatory metadata. The metadata extractor manager may include an addExtractor(resource_type_identifier, extractor, is_mandatory) operation, which takes as parameters, a resource type identifier, an extractor and a Boolean is_mandatory, specifying whether the extractor extracts mandatory metadata.

The metadata extractor manager may include an updateExtractor(resource_identifier, extractor, is_mandatory) operation, which takes as parameters, a resource identifier, an extractor and a Boolean is_mandatory, specifying whether the extractor extracts mandatory metadata. The metadata extractor manager may include an updateExtractor(resource_type_identifier, extractor, is_mandatory) operation, which takes as parameters, a resource type identifier, an extractor and a Boolean is_mandatory, specifying whether the extractor extracts mandatory metadata.

The additional operators/parameters in these operations support specifying whether or not metadata is mandatory. In addition, the updateExtractor operation supports changing a metadata item from being mandatory to optional or vice versa. In embodiments that support late binding of metadata extraction, as described above, or when mandatory metadata is absent, the operation may fail. In some embodiments, there is no difference in behavior based on whether or not late binding of metadata extraction is chosen.

In some embodiments, metadata is designated as immutable. As a non-limiting example, the original author of a document may be the original author, and an additional author may make updates to a document, while the original author remains the same. Ideally, in this scenario, the metadata that contains the original author is immutable so no updates can be made. However, in some embodiments, any associated resource may be represented in a computer system, and it is therefore not possible to enforce true immutability within these embodiments, since any representation may be changed at any time with the appropriate access.

Some disclosed embodiments may include one or more semantic metadata adapter software modules, which may comprise one or more system components that abstract, from the various access patterns of resource management software or libraries, metadata of resources. The semantic metadata adapter may provide a uniform interface for a semantic search engine, as well as deal with resource specific metadata management. In this way, the semantic metadata adapter may be analogous to, and/or work in association with, the metadata extractors and translators disclosed above.

The semantic metadata adapter may further provide an association between concepts, instances, and relationships in the semantic metadata ontology with the inherent metadata of the resources. For example, the word count retrieved from a text document may be associated by the semantic metadata adapter with the concept DocumentWordCount. A semantic search engine asking for the DocumentWordCount may receive the value from the semantic metadata adapter, via a retrieval of the word count.

In embodiments in which metadata is accessible by resource management software, the semantic metadata adapter may invokes a resource management software in order to retrieve the resource's metadata. Depending on the particular resource the appropriate resource management software may be chosen and the correct API invoked. The metadata may then be translated into the appropriate concept, instance or relationship of the semantic metadata ontology.

If resource management software is not available for a resource, then the semantic metadata adapter may process the resource representation itself, if possible, to identify the metadata. If the resource's representation cannot be interpreted, only basic metadata can be determined, such as the resource's size in a specific storage medium, the times of insertion into the knowledge store, and similar metadata that does not depend on the resource's representation. In this case, the translation of the resource's metadata to the semantic metadata ontology takes place as well.

A semantic metadata adapter may be extensible to connect to additional management software, as needed by resources being added to the knowledge store. This extensibility may ensure the ability to deal with new types of resources as they are introduced to the knowledge store.

In case metadata is inaccessible and not available in the resource's representation, the semantic metadata adapter may store semantic metadata about the resource independently of the resource, which may also relate the metadata to the resource. In this case the metadata may be analogous to a resource annotation, which may require the semantic metadata adapter to maintain a persistent association between a specific resource and the resource specific metadata.

For non-inherent resource metadata, the metadata that is directly annotated to the resource based on the semantic metadata ontology, the adapter may access those directly without the need for any extraction or separate storage. Translation may also not be necessary, as the semantic metadata may be in terms of the concepts, relationships and instances of the semantic metadata ontology.

Some disclosed embodiments may support metadata change management, in which metadata may change in conjunction or independent of the resource content itself. Non-limiting examples of such changes to the metadata may include: an update of a metadata value (e.g., number of characters in a document after it was changed); an additional metadata item (e.g., a location added to a photo that did not have location information before); a metadata item which is removed (e.g., an annotation classifying a video was removed after the classification algorithm turned out to be imprecise), and the like.

In some embodiments, when a resource is updated in place, its metadata may be extracted again and the knowledge base may be updated so that the metadata corresponds to the latest content of the resource. If a resource is updated and added as a separate version, then this separate version may be considered a separate resource and its metadata may be extracted as an independent resource.

In embodiments that support late binding, no metadata is actively extracted, only by access, at which time the current state and value of the metadata is handled automatically.

In some embodiments, inconsistencies may arise when a resource is updated. As a non-limiting example, a metadata item declared as mandatory may not be available anymore. In scenarios such as this, the same errors may occur as those which occurred when the resource was added the first time. Resources may also be deleted, and a deletion may cause the metadata in the knowledge base to be deleted, ensuring consistency between the knowledge base and the managed resources.

The disclosed embodiments may support resource changes. In general, resources, once stored, may be immutable. Changes to a resource's content may be done in place, but in some embodiments, revisions of resources may be advantageous over changing the resources that are already stored in place. One aspect of this feature may be security concerns; another may include transparency and version management. Some resources cannot be changed at all (e.g., an email, in which it is not possible to change the email after it was sent). However, in some embodiments, In the presence of versioning, the semantic metadata of a resource may be inherited from a previous version. In these embodiments, the semantic metadata may need to be changed because of the new version of the resource, and may be overwritten in order to reflect the changed content or properties of the resource.

The disclosed embodiments may further support semantic metadata change. In some embodiments, for a given resource, semantic metadata may change, such as an author added as a semantic metadata property. However, in this example, if the author's name was misspelled and must be corrected, correcting the author's name will update the semantic metadata. Because of the importance of capturing the various updates of semantic metadata, semantic metadata itself may be versioned, making it possible to see the history of the semantic metadata for each resource in the knowledge base. In some embodiments, semantic metadata cannot change (e.g., the time and date a resource was first stored in the knowledge base).

Some metadata may be inherent to the resource's content and representation, such as a replay duration, a word count, a language used, and so on. If resource management software is available, the disclosed system may access the metadata and provide the corresponding values. Other metadata may not be inherent to the resource's content or representation, such as a timestamp at which it was added to the knowledge store or in many cases the list of authors. Metadata that is not inherent to the resource is system or user-defined metadata, disclosed herein. In both cases the value of the metadata may be provided and cannot be derived automatically from the resource, in most cases.

For example, authorship may not always be derivable from a resource's content, so a user may provide it, ideally when storing a document into the knowledge store. If the system or user-defined metadata is specified for resource types, then any new resource being added to the knowledge store may have all system or user-defined metadata added at the time when the resource is added to the knowledge store. As a result, at the time of storage, the metadata of a resource is consistent with the system or user-defined metadata specified for the resource type.

It may further be possible that the system or user-defined metadata may be specified for resource type changes. For example, it may be possible, in some embodiments, which users issuing semantic queries want to search for metadata that does not yet exist in the semantic metadata ontology. In order to satisfy the user's future needs, metadata may be added as system-defined or user-defined metadata, which may be accessible by semantic queries. As a consequence additional metadata may be specified for a resource type. If the metadata specified for a resource type changes, then the changes may be reflected in the existing resources of that type, which may already be in the knowledge store. Possibly, the values of the metadata may be added over time (or never), but each resource of a resource type may have all metadata that has been specified for the resource type.

Metadata may be added to, modified in, or deleted from a resource type. When added, all existing resources of that type may have the metadata added. If the value cannot be derived automatically, the added metadata item may not have any value until provided by a user. If deleted, the metadata may be removed from all existing resources of this type. When modified, the modification may be applied to all resources of this resource type.

Metadata of a resource may be accessed through semantic query execution. For metadata that needs to be computed (i.e., cannot be looked up), it must be determined whether the computation of the metadata value is done on demand or if the metadata value is precomputed and stored for future use.

In some embodiments, the semantic metadata adapter may execute do precomputation or on-demand metadata lookup, which may be executed for all possible metadata. As an alternative, for more optimal storage space usage, a more flexible approach may be used in some embodiments, which selectively precomputes metadata values. In some embodiments, users may mark those semantic metadata in the metadata ontology that should be precomputed. This approach may be combined with a heuristic approach that analyzes past metadata usage. If metadata has been accessed in the past (possibly by reaching a certain threshold) this metadata may also be precomputed for the various resources and stored for fast retrieval.

Semantic metadata may be retrieved, inserted, and/or or updated. In some embodiments, the metadata is derived from the resource's content itself. In some embodiments, if the content of a resource changes, the corresponding metadata may also change. In a knowledge store that manages versions of resources and does not update resources in place, the metadata of existing resource versions does not change, either.

In addition to metadata that is inherent to the resource's content, some embodiments may include system and user-defined metadata. System-defined metadata, as introduced above, may be introduced by a system administrator, and may be mandatory for all resources. Each time a resource is added to the knowledge store, system-defined metadata may also be populated with appropriate values. In these embodiments, system-defined metadata may be specific to a resource type, so that a resource being stored needs to support this metadata only if the resource is of that type.

The same principle may be applied to user-defined metadata. A resource being stored in the knowledge store may provide for the user-defined metadata that applies to the resource because it is defined for all resources of the knowledge store or for the type of the resource.

In some embodiments, metadata may be updated by any user, unless access control is enforced. Access control may be enforced for many reasons. For example, security may be enforced to ensure that only authorized users may change metadata on specific resources. Another example may include quality control. Before a user makes an update, a review process may have to be completed to ensure the proper quality of the update.

As disclosed above, in some embodiments, metadata of resources may be translated to a semantic metadata ontology in order to make it accessible to semantic queries. The ontology may consist of a core that defines the concepts, instances and relationships that are most common, such as the date a resource was added to the knowledge store, or a resource's size. The semantic metadata adapter, or the metadata extraction and translation software modules described above, may translate a resource's metadata to the corresponding concept, instance or relationship in the semantic metadata ontology, unless, for example, the metadata is annotated using the semantic metadata ontology, in which case, no translation would be necessary.

There is no single perfect structure for the semantic metadata ontology. The above categorization of metadata may be used to structure it, but depending on the metadata that needs to be described, other categories may work as well.

An aspect of the semantic metadata ontology which should be noted is the ability to extend it. As resources are added to a knowledge store over time, it is possible that those have additional metadata that has not yet been defined in the semantic metadata ontology. In order to make this additional metadata accessible to semantic queries the semantic metadata ontology may be extended.

As noted above, a resource's metadata may reside in different locations. One example location may include the resource's representation itself. To retrieve a metadata value, the representation may be accessed. A second example location may include the storage system. The size of a resource may be determined by retrieving the appropriate value from the storage system. A third example location may include the knowledge store, which may contain some of a resource's metadata, such as the date and time that the resource was added to the knowledge store. Another example location may include a separate database system that stores the metadata of resources separately from the resource or knowledge store.

A knowledge store may support annotating resources, and the same functionality may be used to annotate resources with metadata from the semantic metadata ontology. If a user wants to add metadata to a resource, the user may create a metadata annotation by referring to a concept, instance, or relationship in the semantic metadata ontology, and provide the corresponding value, thereby making the semantic metadata accessible to the semantic query engine like any of the other non-metadata annotations.

Directly annotating resources may also be used for pre-computing metadata. If some of a resource's semantic metadata is pre-computed, the pre-computed values may be added to the resource by means of a metadata annotation that refers to the semantic metadata ontology. Any update to the pre-computed metadata values may be stored in the metadata annotation as soon as the pre-computation allows it.

To make metadata annotations of a resource complete, all metadata values may be added to a resource as a metadata annotation. Metadata from a resource's representation, as well as storage system, can be extracted and added as a metadata annotation also. In this case, the complete set of metadata of a resource may be available as annotation in a consistent way. A semantic query execution engine is not required to implement a special approach for metadata and it is independent of the metadata adapter.

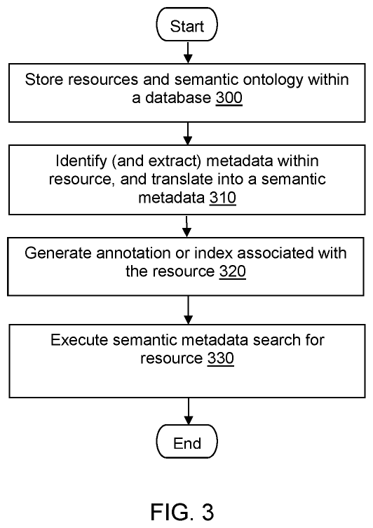

FIG. 3 demonstrates a series of method steps executed by the disclosed system. In this non-limiting example embodiment, a server may comprise a computing device coupled to a network and comprising at least one processor executing instructions within a memory. In step 300, the server may be configured to store, within a database a plurality of resources comprising a plurality of electronic data items and a semantic ontology within a knowledge model, comprising a uniform structure defining a plurality of relationships between a plurality of concepts. In step 310, the server may be configured to identify (and extract) a metadata associated with a resource in the plurality of resources, and translate the metadata from a native representation into a semantic metadata comprising a semantic representation of the metadata defining: a first instance, within the metadata, of a first concept within the semantic ontology; and a relationship, according to the semantic ontology, between the first instance and the resource, a second concept, or a second instance of the second concept. The server may then store an instance of the semantic representation within a knowledge base. In step 320, the server may be configured to generate an annotation or index, associated with the resource in the database, comprising a translation of the metadata into the semantic metadata. In step 330, server may be configured to execute a semantic metadata search. This may include receiving, from a client device, a semantic metadata search request comprising a user input identifying: the first instance of the first concept; the relationship; and the resource, the second concept, or the second instance of the second concept. The server may then select, from the database, the resource associated in the database with the annotation or index matching the user input, and display, on the client device, a list including the resource.

Although the present invention has been described with respect to preferred embodiment(s), any person skilled in the art will recognize that changes may be made in form and detail, and equivalents may be substituted for elements of the invention without departing from the spirit and scope of the invention. Therefore, it is intended that the invention not be limited to the particular embodiments disclosed for carrying out this invention, but will include all embodiments falling within the scope of the appended claims.

What is claimed is:

1. A system comprising:
a database storing:
a plurality resources comprising a plurality of electronic data items; and
a semantic ontology within a knowledge model, comprising a uniform structure defining a plurality of relationships between a plurality of concepts;
a server comprising a computing device coupled to a network and comprising at least one processor executing instructions within a memory, which, when executed, cause the system to:
identify a metadata associated with a resource in the plurality of resources;
translate the metadata from a native representation into a semantic metadata comprising a semantic representation of the metadata defining:
a first instance, within the metadata, of a first concept within the semantic ontology; and
a relationship, according to the semantic ontology, between the first instance and the resource, a second concept, or a second instance of the second concept; and
store an instance of the semantic representation within a knowledge base;
generate an annotation or index, associated with the resource in the database, comprising a translation of the metadata into the semantic metadata;
receive, from a client device, a semantic metadata search request comprising a user input identifying:
the first instance of the first concept;
the relationship; and
the resource, the second concept, or the second instance of the second concept;
select, from the database, the resource associated in the database with the annotation or index matching the user input; and
display, on the client device, a list including the resource.

2. The system of claim 1, further comprising at least one resource type manager software executed by the server, and configured to execute, within the instructions:
a create resource type function configured create a resource type comprising a resource type name received as user input from a Graphical User Interface (GUI), and store the resource type in the database;
a read resource type function configured to select the resource type from the database;
an update resource type function configured to update the resource type within the database; and
a delete resource type function configured to delete the resource type from the database.

3. The system of claim 2 wherein the resource type manager software is further configured to execute, within the instructions:
a create annotation specification function configured to create an annotation specification defining at least one parameter for at least one annotation associated with the resource, and received as user input from the GUI, and store the annotation specification in the database;
a read annotation specification function configured to select the annotation specification from the database;
an update annotation specification function configured to update the annotation specification within the database; and
a delete function configured to delete the annotation specification from the database.

4. The system of claim 3, further comprising at least one resource instance manager software executed by the server, and configured to execute, within the instructions:
a create resource instance function configured to create a resource instance according to a location of the resource and the resource type received as user input from the GUI, and store the resource instance in the database;
a read function configured select the resource instance from the database;
an update function configured update the resource instance within the database; and
a delete function configured to delete the resource instance from the database.

5. The system of claim 4 wherein the resource instance manager software is further configured to execute, within the instructions:
a create annotation instance function configured to create an annotation instance of at least one annotation associated with the resource and the resource specification, and received as user input from the GUI, and store the annotation instance in the database;
a read annotation instance function configured to select the annotation instance from the database;
an update annotation instance function configured to update the annotation instance within the database; and
a delete annotation instance function configured to delete the annotation specification from the database.

6. The system of claim 1, further comprising at least one knowledge model manager software executed by the server, and configured to execute, within the instructions:
a create concept and relationship function configured create the semantic ontology according to user input received from a GUI defining at least one concept and at least one relationship, and store the at least one concept and the at least one relationship in the database;
a read concept and relationship function configured to select the at least one concept and the at least one relationship from the database;
an update concept and relationship function configured to update the at least one concept and the at least one relationship within the database; and
a delete concept and relationship function configured to delete the at least one concept and the at least one relationship from the database.

7. The system of claim 1, further comprising at least one metadata extraction manager software executed by the server, and configured to execute, within the instructions:
a create metadata extractor function configured create at least one metadata extractor from user input received from a GUI identifying the resource and defining at least one parameter for extracting the metadata from the resource, and store the metadata extractor in the database;
a read metadata extractor function configured to select the metadata extractor from the database;
an update metadata extractor function configured to update the metadata extractor within the database;
a delete metadata extractor function configured to delete the metadata extractor from the database; and
a metadata extraction function configured to extract the metadata from the resource.

8. The system of claim 1, further comprising at least one metadata translation manager software executed by the server, and configured to execute, within the instructions:
a create metadata translation rule function configured create at least one metadata translation rule from user input received from a GUI defining at least one rule for translating the metadata associated with the resource into the semantic metadata, and store the metadata translation rule in the database;
a read metadata translation rule function configured to select the metadata translation rule from the database;
an update metadata translation rule function configured to update the metadata translation rule within the database;
a delete metadata translation rule function configured to delete the metadata translation rule from the database; and
a metadata translation function configured to translate the metadata associated with the resource into the semantic metadata.

9. A method comprising:
storing within a database, by a server comprising a computing device coupled to a network and comprising at least one processor executing instructions within a memory:
a plurality resources comprising a plurality of electronic data items; and
a semantic ontology within a knowledge model, comprising a uniform structure defining a plurality of relationships between a plurality of concepts;
identifying, by the server, a metadata associated with a resource in the plurality of resources;
translating, by the server, the metadata from a native representation into a semantic metadata comprising a semantic representation of the metadata defining:
a first instance, within the metadata, of a first concept within the semantic ontology; and
a relationship, according to the semantic ontology, between the first instance and the resource, a second concept, or a second instance of the second concept; and
storing, by the server, an instance of the semantic representation within a knowledge base;
generating, by the server, an annotation or index, associated with the resource in the database, comprising a translation of the metadata into the semantic metadata;
receiving, by the server from a client device, a semantic metadata search request comprising a user input identifying:
the first instance of the first concept;
the relationship; and
the resource, the second concept, or the second instance of the second concept;
selecting, by the server from the database, the resource associated in the database with the annotation or index matching the user input; and
displaying, by the server on the client device, a list including the resource.

10. The method of claim 9, further comprising the step of executing, by the server, at least one resource type manager software comprising:
a create resource type function configured to create a resource type comprising a resource type name received as user input from a Graphical User Interface (GUI), and store the resource type in the database;
a read resource type function configured to select the resource type from the database;
an update resource type function configured to update the resource type within the database; and
a delete resource type function configured to delete the resource type from the database.

11. The method of claim 10 wherein the resource type manager software further comprises:
a create annotation specification function configured to create an annotation specification defining at least one parameter for at least one annotation associated with the resource, and received as user input from the GUI, and store the annotation specification in the database;
a read annotation specification function configured to select the annotation specification from the database;
an update annotation specification function configured to update the annotation specification within the database; and
a delete function configured to delete the annotation specification from the database.

12. The method of claim 11, further comprising the step of executing, by the server, at least one resource instance manager software comprising:
a create resource instance function configured to create a resource instance according to a location of the resource and the resource type received as user input from the GUI, and store the resource instance in the database;
a read function configured select the resource instance from the database;
an update function configured update the resource instance within the database; and
a delete function configured to delete the resource instance from the database.

13. The method of claim 12 wherein the resource instance manager software further comprises:
a create annotation instance function configured to create an annotation instance of at least one annotation associated with the resource and the resource specification, and received as user input from the GUI, and store the annotation instance in the database;
a read annotation instance function configured to select the annotation instance from the database;
an update annotation instance function configured to update the annotation instance within the database; and
a delete annotation instance function configured to delete the annotation specification from the database.

14. The method of claim 9, further comprising the step of executing, by the server, at least one knowledge model manager software comprising:
a create concept and relationship function configured to create the semantic ontology according to user input received from a GUI defining at least one concept and at least one relationship, and store the at least one concept and the at least one relationship in the database;
a read concept and relationship function configured to select the at least one concept and the at least one relationship from the database;
an update concept and relationship function configured to update the at least one concept and the at least one relationship within the database; and
a delete concept and relationship function configured to delete the at least one concept and the at least one relationship from the database.

15. The method of claim 9, further comprising the step of executing, by the server, at least one metadata extraction manager software comprising:
a create metadata extractor function configured to create at least one metadata extractor from user input received from a GUI identifying the resource and defining at least one parameter for extracting the metadata from the resource, and store the metadata extractor in the database;
a read metadata extractor function configured to select the metadata extractor from the database;
an update metadata extractor function configured to update the metadata extractor within the database;
a delete metadata extractor function configured to delete the metadata extractor from the database; and
a metadata extraction function configured to extract the metadata from the resource.

16. The method of claim 9, further comprising the step of executing, by the server, at least one metadata translation manager software comprising:
a create metadata translation rule function configured create at least one metadata translation rule from user input received from a GUI defining at least one rule for translating the metadata associated with the resource into a semantic metadata, and store the metadata translation rule in the database;
a read metadata translation rule function configured to select the metadata translation rule from the database;
an update metadata translation rule function configured to update the metadata translation rule within the database;
a delete metadata translation rule function configured to delete the metadata translation rule from the database; and
a metadata translation function configured to translate the metadata associated with the resource into the semantic metadata.

17. A system comprising a server comprising a computing device coupled to a network and comprising at least one processor executing instructions within a memory, and configured to:
store, within a database:
a plurality resources comprising a plurality of electronic data items; and
a semantic ontology within a knowledge model, comprising a uniform structure defining a plurality of relationships between a plurality of concepts;
identify a metadata associated with a resource in the plurality of resources;
translate the metadata from a native representation into a semantic metadata comprising a semantic representation of the metadata defining:
a first instance, within the metadata, of a first concept within the semantic ontology; and
a relationship, according to the semantic ontology, between the first instance and the resource, a second concept, or a second instance of the second concept; and
store an instance of the semantic representation within a knowledge base;
generate an annotation or index, associated with the resource in the database, comprising a translation of the metadata into the semantic metadata;
receive, from a client device, a semantic metadata search request comprising a user input identifying:
the first instance of the first concept;
the relationship; and
the resource, the second concept, or the second instance of the second concept;
select, from the database, the resource associated in the database with the annotation or index matching the user input; and
display, on the client device, a list including the resource.

18. The system of claim 17, wherein the metadata is identified within the system as:
inherent metadata derived from the resource; or
non-inherent metadata independent of the resource.

19. The system of claim 18, wherein server is further configured to identify the inherent metadata by:
accessing the metadata via a resource representation management software; or
accessing the metadata via an interpretation of the content within the resource.

20. The system of claim 18, wherein server is further configured to identify the non-inherent metadata by:
identifying a term or phrase within the content of the resource; or
accessing an annotation independent of a resource representation.
